(19) United States
(12) Patent Application Publication
(10) Pub. No.: US 2023/0370282 A1
(43) Pub. Date: Nov. 16, 2023

(54) DISTRIBUTED LEDGER BASED CRYPTOGRAPHIC SYSTEMS AND METHODS FOR IMPROVING DATA INTEGRITY

(71) Applicant: TBCASOFT, INC., Sunnyvale, CA (US)

(72) Inventors: Kyle HUANG, Taipei City (TW); Chiahsin LI, San Jose, CA (US); Andrew TULLY, Fishers, IN (US); Eric JANG, Newark, CA (US)

(21) Appl. No.: 18/030,764

(22) PCT Filed: Oct. 6, 2021
(86) PCT No.: PCT/US21/53868

§ 371 Date: Apr. 6, 2023

Related U.S. Application Data
(60) Provisional application No. 63/088,412, filed on Oct. 6, 2020.

(51) Int. Cl. H04L 9/32; H04L 9/08

(52) U.S. Cl. CPC H04L 9/3247; H04L 9/3218; H04L 9/3268; H04L 9/0825

(57) ABSTRACT

The present disclosure describes system and method for using distributed ledgers to improve data integrity. The system may include a distributed integrity ledger, a distributed identity ledger, multiple network node managers to manage transactions in both ledgers, a data recording device, a manufacture to make the device, a user to use the device, a data center to store recorded data pieces, and a verifier who needs to verify authenticity of the recorded data. The distributed integrity ledger is used to store commitments generated by the data recording device to verify authenticity of recorded data pieces. In addition, because the commitment is neither traceable nor linkable to personal information, possibility of privacy violation is minimized even if the commitments are disclosed to the public.

### RELATED APPLICATIONS

This application claims the priority of U.S. provisional application 63/088,412 filed on Oct. 6, 2020, titled “ BLOCKCHAIN BASED MEDIA ANTI-TAMPERING METHODS AND SYSTEMS”.

This application claims the benefit of U.S. non-provisional application 16/801,114 filed on Feb. 25, 2020, titled “CREDENTIAL VERIFICATION AND ISSUANCE THROUGH CREDENTIAL SERVICE PROVIDERS”, which is incorporated herein by reference at its entirety.

### BACKGROUND OF THE INVENTION

### Field of the Invention

The present invention is related to a distributed ledger based cryptographic systems and methods for improving the integrity and privacy of data; more specifically, a blockchain based cryptographic systems and methods for securing the integrity and privacy of private data which are generated from a data recording device and stored remotely in a remote data storage.

### Description of Related Art

The emergence of distributed ledger technologies (DLT), including blockchains, offers a solution to improve data integrity. DLT is trusted because transactions recorded in such a distributed ledger across the entire network of nodes are very difficult or even impossible to alter. For this reason, various blockchain security methods have been implemented to provide secure transactions across networks. The blockchain itself may be regarded as an open and distributed ledger that can record transactions between parties. After a block in the blockchain is recorded and linked, the data in any given block cannot be altered or tampered without altering all the other blocks; therefore, blockchain is well suited to many records management activities such as cryptocurrency. However, DLT such as blockchains may be secure and transparent at the same time because transactions are recorded in a large number of blocks or network nodes forming the distributed transaction consensus network. Thus, recording data themselves in a distributed ledger may cause privacy issues or even violate the related regulations. Furthermore, there has been few DLT based cryptographic system and method for maintaining the integrity and privacy of data which are generated from a data recording device and stored remotely in a remote data storage. Therefore, the present invention aims to implement DLT technology to protect the integrity of the data which are generated from the data recording device, such as a surveillance camera, driving recorder, or a mobile device.

### SUMMARY

The present disclosure relates to distributed ledger based cryptographic systems and methods for improving data integrity. In the age of IOT (internet of things), various types of data are recorded by different devices at any moment and circulated via various wired and wireless networks. In addition, the advanced data processing technologies also cause the data recorded by a data recording device can be easily corrupted, falsified, forged, tampered, or altered without authority. As mentioned earlier, the distributed ledger technologies (DLT), including blockchains, offers a solution to improve data integrity.

The present disclosure describes systems and methods to generate a commitment and store it in a distributed ledger. A commitment is a cryptographic algorithm that allows one to commit to a chosen value or statement while keeping it hidden to others, with the ability to reveal the committed value later. Commitment is binding because the one who committed can no longer change the chosen value or statement. Here, the chosen statement is a data signature which is generated by a data recording device signing a data piece. Recording the commitment in a distributed ledger makes it very difficult or even impossible to alter the commitment. In addition, the committed value or statement, such as the data signature, cannot be changed as well. By revealing the commitment in the future, the data signature will be verified. And then the authenticity of the data piece will be verified. At the same time, the commitment does not contain any personal information, and is not traceable or even linkable to the data piece recorded by a data recording device, such as a digital video recorder.

In one embodiment, the ecosystem for using distributed ledgers to improve data integrity may include a distributed integrity ledger, a distributed identity ledger, multiple network node managers to manage transactions in both ledgers, a data recording device, a manufacturer to make the device, a user to use the device, a data center to store recorded data pieces, and a verifier who needs to verify authenticity of the recorded data.

In one embodiment, the distributed integrity ledger, maintained by a first distributed transaction consensus network (“first distributed network”), is used to store commitments generated by the data recording device to verify authenticity of recorded data pieces. The distributed identity ledger, maintained by a second distributed transaction consensus network (“second distributed network”), is used to store DIDs (decentralized identifier), credential schemas, credential definitions, and public keys associated with credential owners and credential publishers to verify the identity of the user, the data center, and the verifier. The multiple network node managers may respectively manage a node in the first distributed network and the second distributed network. Thus, the network node managers may record transactions and retrieve information from both the distributed integrity ledger and the distributed identity ledger.

In one embodiment, the data recording device may be any device that is able to record data and transmit data to other related parties in various wired or wireless manners. In one embodiment, the data recording device may be a digital recorder or driving recorder to record video clips of the surrounding traffic conditions.

In one embodiment, the manufacturer may store an original device certificate, a device signing private key and a device signing public key, and some other device related information in the data recording device. After the user purchases the data recording device, he/she has to register the device with the manufacturer. The user also has to establish a DID, a user identification, in the distributed identity ledger. Then the user can begin to use the data recording device to record data pieces.

In one embodiment, each recorded data piece is encrypted by a data encryption key and an encrypted data piece is transmitted to the data center for storage. The data recording device also generated a data signature, a commitment string and a commitment. The data signature and the commitment string may be stored in the data center. The commitment may be recorded in the distributed integrity ledger through a network node manager.

In one embodiment, the user may initiate the verification procedure for the verifier to eventually receive a data encryption key, an encrypted data piece, the commitment, the data signature, and the commitment string. As a result, the verifier, such as the judge/the court, may decrypt the encrypted data piece by using the data encryption key, verify the authenticity of the recorded data by using the data signature, verify the data signature by using the commitment and the commitment string, and verify the commitment by inquiring the distributed integrity ledger.

### BRIEF DESCRIPTION OF THE DRAWINGS

FIG. 1 is a schematic view of the ecosystem for using distributed ledgers to improve data integrity in accordance with an embodiment of the present invention.

FIG. 2 is a schematic view of the manufacturing stage of the data recording device in the distributed ledger based cryptographic system and method in accordance with the embodiment of the present invention.

FIG. 3 is a schematic view of the registration stage of the data recording device in the distributed ledger based cryptographic system and method in accordance with the embodiment of the present invention.

FIG. 4 is a schematic view of the data recording stage of the distributed ledger based cryptographic system and method in accordance with the embodiment of the present invention.

FIG. 5 is a schematic view of the verification stage of the distributed ledger based cryptographic system and method in accordance with the embodiment of the present invention.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The present disclosure relates to distributed ledger based cryptographic systems and methods for improving data integrity. In the age of IOT (internet of things), various types of data are recorded by different devices at any moment and circulated via various wired and wireless networks. In addition, the advanced data processing technologies also cause the data recorded by a data recording device can be easily corrupted, falsified, forged, tampered, or altered without authority. The emergence of distributed ledger technologies (DLT), including blockchains, offers a solution to improve data integrity. DLT is trusted because transactions recorded in such a distributed ledger across the entire network of nodes are very difficult or even impossible to alter. However, DLT may be transparent at the same time because transactions are recorded in a large number of network nodes forming the distributed transaction consensus network. Thus, recording data themselves in a distributed ledger may cause privacy issues or even violate the related regulations.

The present disclosure describes systems and methods to generate a commitment and store it in a distributed ledger. A commitment is a cryptographic algorithm that allows one to commit to a chosen value or statement while keeping it hidden to others, with the ability to reveal the committed value later. Commitment is binding because the one who committed can no longer change the chosen value or statement. Here, the chosen statement is a data signature which is generated by a data recording device signing a data piece. Recording the commitment in a distributed ledger makes it very difficult or even impossible to alter the commitment. In addition, the committed value or statement, such as the data signature, cannot be changed as well. By revealing the commitment in the future, the data signature will be verified. And then the authenticity of the data piece will be verified. At the same time, the commitment does not contain any personal information, and is not traceable or even linkable to the data piece recorded by a data recording device, such as a digital video recorder.

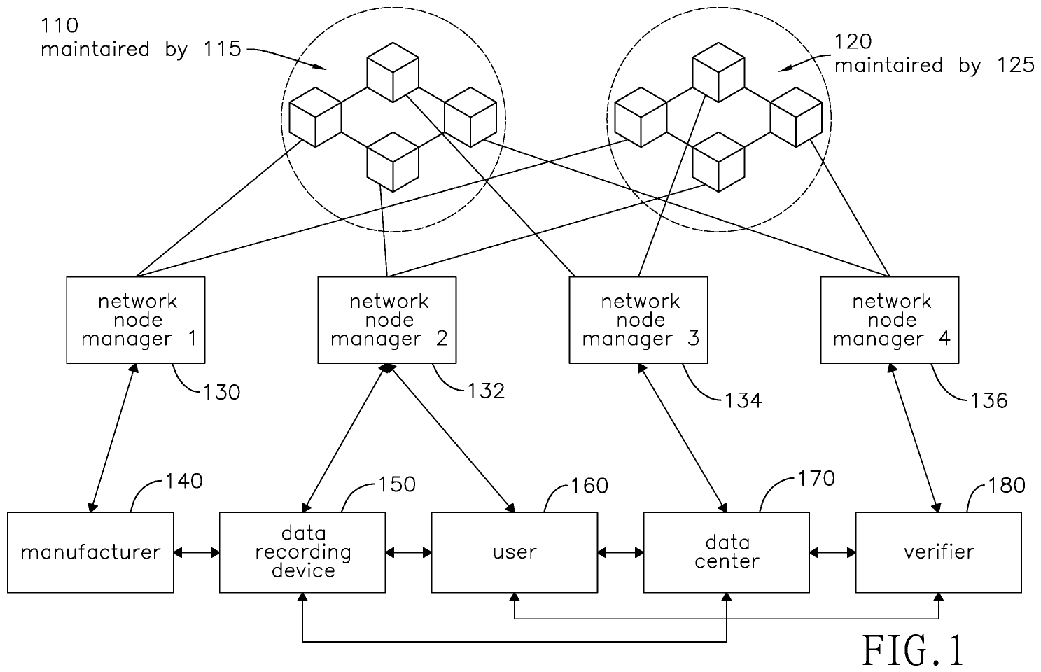

As shown in FIG. 1, The ecosystem 100 for using distributed ledgers to improve data integrity may include a distributed integrity ledger 110, a distributed identity ledger 120, multiple network node managers 130, 132, 134, 136 to manage transactions in both ledgers, a data recording device 150, a manufacture 140 to make the device, a user 160 to use the device, a data center 170 to store recorded data pieces, and a verifier 170 who needs to verify authenticity of the recorded data.

The distributed integrity ledger 110, maintained by a first distributed transaction consensus network (“first distributed network”) 115, is used to store commitments generated by the data recording device 150 to verify authenticity of recorded data pieces. The distributed identity ledger 120, maintained by a second distributed transaction consensus network (“second distributed network”) 125, is used to store DIDs (decentralized identifier), credential schemas, credential definitions, and public keys associated with credential owners and credential publishers to verify the identity of the user 160, the data center 170, and the verifier 180. The multiple network node managers 130, 132, 134, 136 may respectively manage a node in the first distributed network and the second distributed network. Thus, the network node managers may record transactions and retrieve information from both the distributed integrity ledger 110 and the distributed identity ledger 120. The network node managers may be telecommunication carriers, such as ATT and Sprint in the United States, organizations operated by government agencies, or other DLT related companies, such as TBCASOFT. One of the network node managers may be a network administrator. In one embodiment, certain function, such as generating a DID and recording it in the distributed identity ledger 120 is reserved for the network administrator.

The data recording device 150 may be any device that is able to record data and transmit data to other related parties via various wired or wireless manners. In one embodiment, the data recording device 150 may be a digital recorder or driving recorder to record video clips of the surrounding traffic conditions. The data recording device 150 may have a recording module for recording a data piece, a memory module for storing an original device certificate signed by a manufacturer, a device signing public key, and a device signing private key; and a processor module for generating a data encryption key, encrypting the data piece with the data encryption key, encrypting the data encryption key with the encryption public key.

The data recording device 150 is made by the manufacturer 140. As part of the manufacturing process, the manufacturer 140 may store an original device certificate, a device signing private key and a device signing public key, and some other device related information in the data recording device 150. After the user 160 purchases the data recording device 150, he/she has to register the device with the manufacturer 140. The user also has to establish a DID, a user identification, in the distributed identity ledger.

Then the user 160 can begin to use the data recording device to record data pieces. Each recorded data piece is encrypted by a data encryption key and an encrypted data piece is transmitted to the data center 170 for storage. The data recording device 150 also generated a data signature, a commitment string and a commitment. The data signature and the commitment string may be stored in the data center 170. The commitment may be recorded in the distributed integrity ledger 110 through a network node manager.

The need for verifying authenticity of the recorded data occurs in various situations. For example, when there is a car accident and the liability is in dispute, a user or a judge/a court may need to review the video clip recorded by a driving recorder at the time of accident and verify authenticity of the recorded video clip. In one embodiment, the user 160 may initiate the verification procedure for the verifier to eventually receive a data encryption key, an encrypted data piece, the commitment, the data signature, and the commitment string. As a result, the verifier, such as the judge/the court, may decrypt the encrypted data piece by using the data encryption key, verify the authenticity of the recorded data by using the data signature, verify the data signature by using the commitment and the commitment string, and verify the commitment by inquiring the distributed integrity ledger 110.

The manufacturer 140, the data recording device, the user, the data center, and the verifier may need to interact with either one of or both the distributed integrity ledger 110 and the distributed identity ledger 120 through one of the network node managers 130, 132, 134, 136. Each may have its own network node manager. In another embodiment, two wo or more may share the same network node manager.

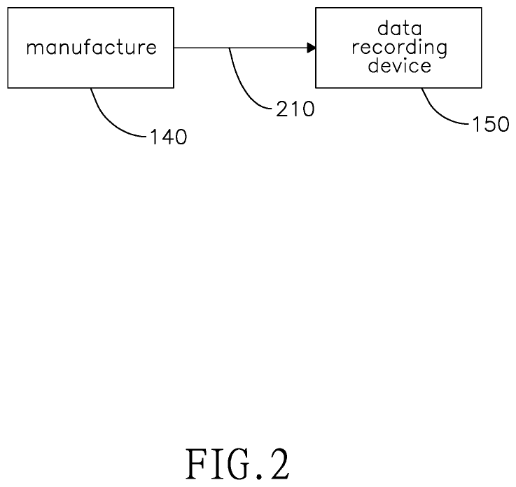

As shown in FIG. 2, in a manufacturing stage, the manufacturer 140 generates an original device certificate by signing some product information, such as a module number and a serial number, with a manufacturer's private key. The manufacturer 140 has a pair of signing keys, a signing private key and a signing public key. As described above, the manufacturer's signing private key is used to sign the product information to generate a device certificate, including an original device certificate and an updated device certificate. The manufacturer's signing public key is distributed to others, such as a network node manager, who need to verify the authenticity of information provided and signed by the manufacturer's signing private key. The manufacturer 140 also generates a pair of signing keys for the data recording device 150, a device signing private key and a device signing public key. The manufacturer 140 stores the original device certificate, the device signing private key and the device signing public key in the data recording device. Additional product information, such as warranty period, country of origin, date of manufacture, etc., may be stored in the data recording device 150 as well. The manufacturer 140 may outsource manufacturing to OEM or ODM. Thus, the steps described above may be implemented by other parties working for the manufacturer 140. For this disclosure, these other parties are considered as the manufacturer 140.

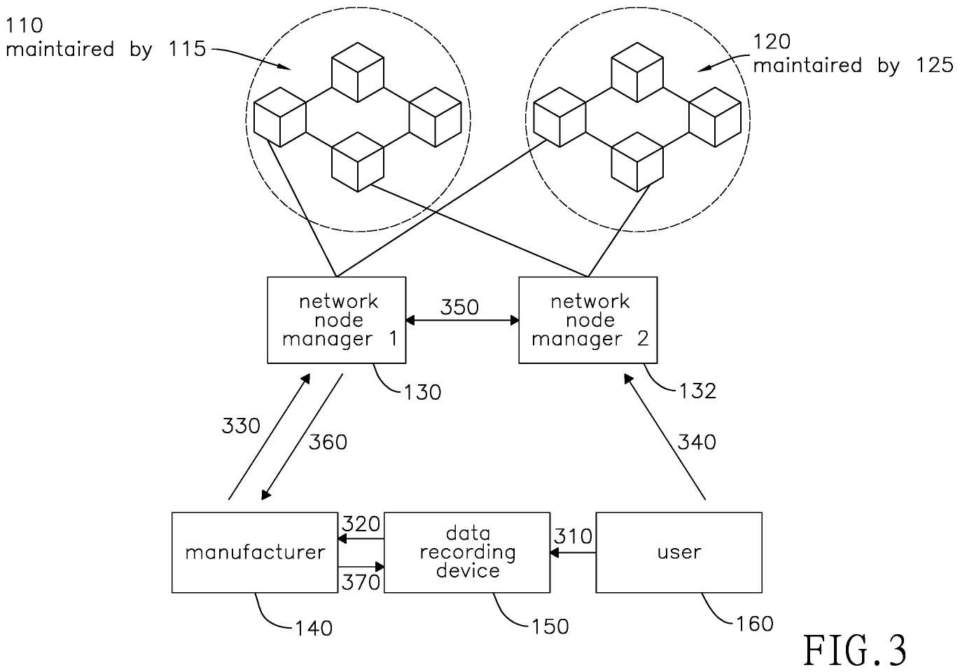

FIG. 3 illustrates interactions between the user 160, the data recording device 150, the manufacturer 140, the network node manager 130, and the distributed identity ledger 120 in a registration stage. After the user 160 obtains the data recording device 150, for example through purchase, the user 160 initiates the device registration stage by turning on the data recording device 150 and causing it to connect with the manufacturer 140 for information transmission via wired or wireless manner At step 310, the user 160 may need to input his/her own personal information, such as user ID, name, gender, and birthday, to the data recording device 150. At step 320, the data recording device 150 provides to the manufacturer 140 the device signing public key, the original device certificate, the user related information received from the user at step 310, and other device related information, for example a car plate number of the car in which a driving recorder is installed. Some of the above-mentioned information may be optional. For example, the manufacturer 140 may still keep the device signing public key for the data recording device 150.

The manufacturer 140 then verifies the original device certificate by using the manufacturer's signing public key to confirm that the original device certificate is authentic. At step 330, after verification, the manufacturer 140 provides the device signing public, the original device certificate, and information related to the device and the user to the network node manager 130. At step 340, the user 160 may also provide his/her personal information, such as user ID, name, gender, and birthday and the device related information to the network node manager 132. As described before, the manufacturer 140 may use its own network node manager 130 and the user 160 uses his/her own network node manager 132. The manufacturer 140 and the user may also use the same network node manager (either 130 or 132).

Thus, between the two network node managers 130 and 132, the following processes have to be performed. First, the network node manager (130 or 132) may verify the original device certificate by using the manufacturer's signing public key. Second, the network node manager may verify the user's DID via the distributed identity ledger 120 and possibly also verify other user's information via the user's ID credential, given that the user 160 already has a DID recorded in the distributed identity ledger 120. If the user 160 is new, a DID has to be created to the user and recorded in the distributed identity ledger 120. The user's DID serves as a user identification. One example of DID is did.sovrin.V4SDRN84Z56d7YV7PBUe6f. Similar to virtual wallet addresses, DIDs are globally unique identifiers that are created by their owner or their network node managers. DIDs have their associated public keys and communication endpoints—addresses where messages can be delivered for that identity. The credential owners of the DIDs hold the corresponding private keys in their wallets that can be managed by their network node managers.

Third, the network node manager (either 130 or 132) generates a pair of encryption keys for the data recording device, an encryption private key and an encrption public key. Fourth, the network node manager (either 130 or 132) issues a user's device credential to the user 160. The user's device credential may include the following fields: user's DID, the device signing public key, the encryption public key, the device information, and the user information. In one embodiment, the device information may include the model number and the serial number of the driving recorder, the car plate number of the car in which the driving recorder is installed, and the model and color of the car. And the user information includes the driver's name, birthday, and the driver's license number. Fifth, the network node manager (either 130 or 132) generates a proof for the user's device credential including the encryption public key. Step 350 is for the two network node managers 130 and 132 to provide related information to each other to accomplish the above five processes.

At step 360, the network node manager (either 130 or 132) provides the manufacturer 140 the proof of the user's device credential, the encryption public key and the user's DID. The manufacturer 140 may verify the proof of the user's device credential. After verification is valid, the manufacturer 140 generates an updated device certificate which is signed by the manufacturer's signing private key. The updated device certificate includes the user's DID, the encryption public key, and the device related information. At step 370, the manufacturer 140 provides the data recording device 150 the proof for the updated device certificate, the user's DID, and the encryption public key.

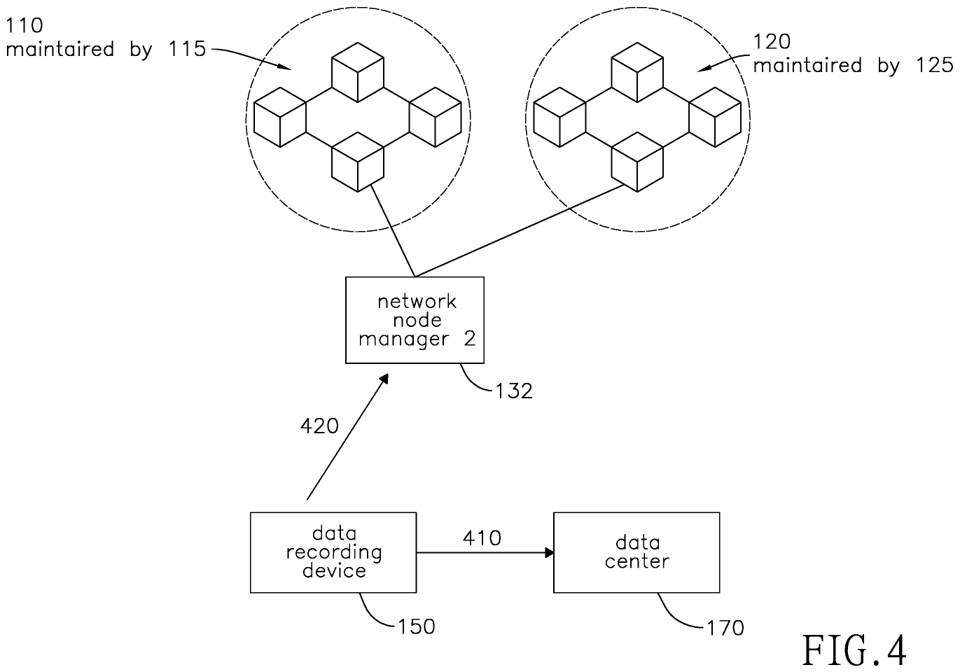

FIG. 4 illustrates interactions between the data recording device 150, the data center, the network node manager 132, and the distributed integrity ledger 110 in a recording stage. Once its recording function is turned on, the data recording device 150 begins to record a data piece. First, the data recording device 150 generates a data encryption key for the recorded data piece and then encrypts the recorded data piece to derive an encrypted data piece. Second, the data recording device 150 encrypts the data encryption key by using the encryption public key to generate an encrypted data encryption key. Third, the data recording device 150 signs the recorded data piece with the device signing private key to generate a data signature. Fourth, the data recording device 150 generates a commitment string. A commitment string may be a random number, such as a 256 bits number like ba3253876aed6bc22d4a6ff53d8406c6ad864195ed144ab5c87621b6c233b548. Then, the data recording device 150 generates a commitment using the commitment string to lock the data signature. One example of the commitment is 3627909a29c31381a071ec27f7c9ca97726182aed29a7ddd2e54353322cfb30a. Fifth, the data recording device 150 generates a commitment signature by signing the commitment with the device signing private key.

At step 410, the data recording device 150 provides the data center 170 the encrypted data piece, the encrypted data encryption key, the data signature, the commitment, and the commitment string for storage. In some situations, the updated device certificate and the related device information may be provided from the data recording device 150 to the data center 170 as well. At step 420, the data recording device provides the commitment, the commitment signature, the updated device certificate, and the device related information to the network node manager 132.

The network node manager 132 first verifies the updated device certificate by using the manufacturer's signing public key and then verifies the commitment by using the commitment signature and the device signing public key. After confirmation, the network node manager 132 writes (records) the commitment to the distributed integrity ledger 110. Again the netowrk node manager in the recording stage may be any network node manager.

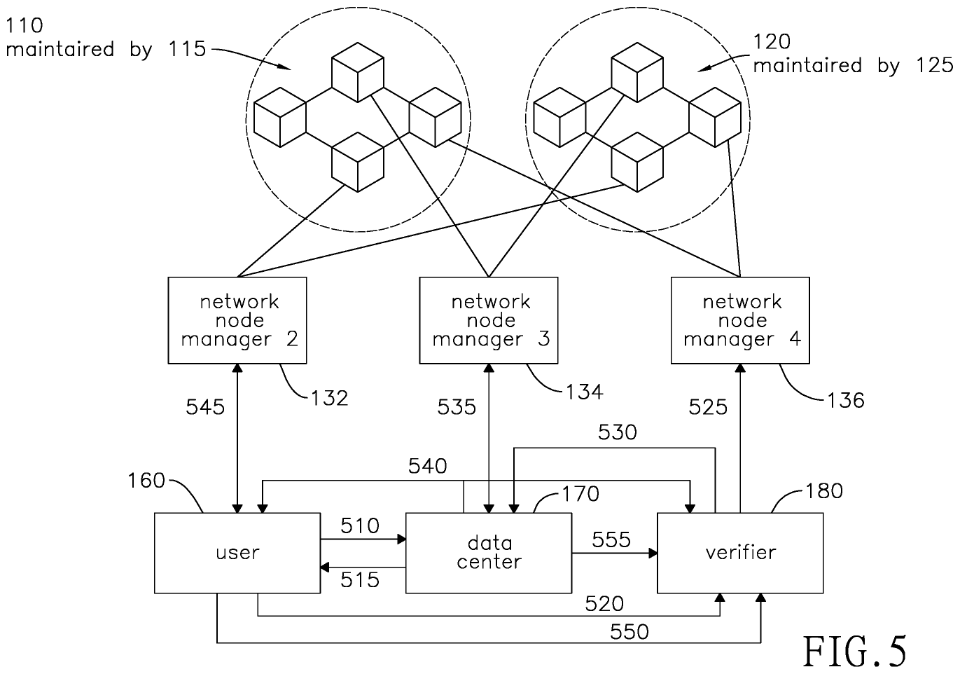

FIG. 5 illustrates interactions between the user 160, the data center 170, the verifier 180, their respective network node managers 132, 134, 136, the distributed integrity ledger 110 and the distributed identity ledger 120 in a verification stage. In one embodiment, at step 510, the user 160 initiates the verification stage by providing a proof for the user's ID credential to the data center 170. The data center verifies the proof via its network node manager 134 to access the distributed identity ledger 120. After verification of the proof, at step 515, the data center 170 provides the user 160 the commitment and possibly also some meta data. The user 160 obtains a proof for the user's device credential via its network node manager 132 to access the distributed identity ledgere 120. The user 160 signs the commitment with the user's signing private key to generate a user's authorization. At step 520, the user 160 provides the verifier 180 the commitment, a proof for the user's ID credential, and the user's authorization. At step 525, the verifier 180 verifies the proof for the user's ID credential, the user's authorization via its network node manager 136 to access the distributed identity ledger 120. Then the verifier 180 looks up the commitment to confirm its existence via its network node manager 136 to access the distributed integrity ledger 110. After verification and confirmation, the verifier 180 signs the commitment and the user's authorization with the verifier's signing private key to generate the verifier's authorization. At step 530, the verifier 180 provides the data center 170 the commitment, the proof of the verifier's ID credential , the user's authorization, and the verifier's authorization. At step 535, the data center 170 verifies such information via its network node manager 134 to access both distributed ledgers 110, 120. After verification, the data center 170 signs the commitment, the user's authorization, and the verifier's authorization with its signing private key to generate the data center's authorization. At step 540, the data center 170 provides the user 160 and the verifier 180 the data center's authorization. At the same time, the data center 170 also provides the user the encrypted data encryption key. At the same time, the data center 170 also provides the encrypted data piece, the data signature, and the commitment string to the verifier.

Upon receipt of the data center's authorization and the encrypted data encryption key, at step 545, the user obtains encryption private key from the network node manager to decrpyt the encrypted data encryption key to eventually derive the data encryption key. At step 550, the user 160 provides the verifier the data encryption key. The verifier then verifies the data center's authorization, decrypts the encrrypted data piece to derive the original data piece, verifies authenticity of the data piece by the data signature, and verifies the data signature by the commitment.

Below is an embodiment of pseudo code for implementing the methods described above

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the Widest scope consistent With the principles and novel features disclosed herein. It is contemplated that additional embodiments are Within the spirit and true scope of the disclosed subject matter. Thus, it is intended that the present invention covers modifications and variations that come Within the scope of the appended claims and their equivalents.

What is claimed is:

1. A distributed ledger based cryptographic method for a network node manager to improve data integrity, comprising:
receiving, from a data recording device managed by a user, an original device certificate signed by a manufacturer of the data recording device;
verifying the original device certificate; and
verifying a user identification or generating the user identification in a distributed identity ledger.

2. The method of claim 1, further comprising:
generating an encryption private key and the encryption public key for the data recording device.

3. The method of claim 2, further comprising:
generating a user's device credential comprising an encryption public key, and a proof for the user's device credential.

4. The method of claim 1, wherein the data recording device is a digital video recorder.

5. A distributed ledger based cryptographic method for a network node manager to improve data integrity, comprising:
receiving, from a data recording device managed by a user, an updated device certificate signed by a manufacturer of the data recording device, a commitment generated to lock a data signature that is generated by signing a data piece with a device signing private key, and a commitment signature generated by signing the commitment with the device signing private key;
verifying the updated device certificate by using a manufacturer's signing public key;
verifying the commitment by using the commitment signature; and
recording, if verification is valid, the commitment in a distributed integrity ledger maintained by a first distributed transaction consensus network.

6. The method of claim 5, further comprising:
receiving the commitment and a request for confirming the commitment recorded in the distributed integrity ledger; and
confirming with the distributed integrity ledger that the commitment exists.

7. The method of claim 5, further comprising:
receiving a request for an encryption private key of the data recording device and an authorization from the user;
verifying the authorization from the user; and
providing the encryption private key to the user for decrypting the encrypted data encryption key.

8. A distributed ledger based cryptographic method for a data recording device to improve data integrity, comprising:
providing, to a network node manager, a device signing public key previously stored in the data recording device; and
receiving, from the network node manager, an encryption public key and a user identification recorded in a distributed identity ledger maintained by a second distributed transaction consensus network.

9. The method of claim 8, further comprising:
providing, to a manufacturer of the data recording device, an original device certificate stored in the data recording device;
receiving, from the manufacturer of the data recording device, an updated device certificate, including the user identification and the encryption public key, signed by the manufacturer; and
wherein the device signing public key are provided to the network node manager through the manufacturer and the encryption public key and the user identification are received from the network node manager through the manufacturer.

10. The method of claim 8, further comprising:
generating a data encryption key for a data piece;
encrypting the data piece with the data encryption key;
encrypting the data encryption key with the encryption public key;
generating a data signature by signing the data piece with a device signing private key;
generating a commitment string;
generating a commitment to be recorded in a distributed integrity ledger maintained by a first distributed transaction consensus network, by providing the data signature and the commitment string; and
generating a commitment signature by signing the commitment with the device signing private key.

11. The method of claim 8, wherein the data recording device is a digital video recorder.

12. A distributed ledger based cryptographic method for a verifier to improve data integrity, comprising:
receiving an encrypted data piece, a data encryption key, a data signature, a commitment, and a commitment string;
decrypting the encrypted data piece with the data encryption key to obtain the data piece recorded by a data recording device;
verifying authenticity of the data piece by using the data signature and a device signing public key;
verifying that the commitment is recorded in a distributed integrity ledger maintained by a first distributed transaction consensus network; and
verifying the commitment by using the data signature and the commitment string.

13. The method of 12, further comprising:
receiving an authorization from a user of the data recording device or a data center storing the encrypted data piece, the commitment, the data signature, and the commitment string; and
verifying the authorization with a user's signing public key or a data center's signing public key.

14. A data recording device, comprising:
a recording module for recording a data piece;
a memory module for storing an original device certificate signed by a manufacturer, a device signing public key, and a device signing private key; and
a processor module for generating a data encryption key, encrypting the data piece with the data encryption key, encrypting the data encryption key with the encryption public key.

15. The device of claim 14, wherein the processor module generates a data signature by signing the data piece with the device signing private key, a commitment string, and a commitment to lock the data signature.

16. The device of claim 14, wherein the recording module is a digital video recorder.
